(19) United States
(12) Patent Application Publication
(10) Pub. No.: US 2005/0219857 A1
(43) Pub. Date: Oct. 6, 2005

(54) Luminous unit, particularly as an additional light in sideview mirrors of motor vehicles

(75) Inventors: Thomas Klett, Gomaringen (DE); Andreas Erber, Ostfildern (DE); Bernd Waldmann, Nurtingen (DE); Stephanie Strahl-Schafer, Reutlingen (DE)

Correspondence Address: WARN, HOFFMANN, MILLER & LALONE, .P.C, PO BOX 70098, ROCHESTER HILLS, MI, 48307, US

(73) Assignee: Schefenacker Vision Systems Germany GmbH & Co. Kg, Esslingen (DE)

(21) Appl. No.: 10/507,725

(22) PCT Filed: Feb. 14, 2003
(86) PCT No.: PCT/DE03/00444

§ 371 Date: May 31, 2005

(30) Foreign Application Priority Data
Mar. 14, 2002 (DE) 102 11 189.8

(51) Int. Cl. F21V 7/00

(52) U.S. Cl. 362/518; 362/545

(57) ABSTRACT

The light of luminous units known in prior art is laterally radiated, wherefore LEDs (10 to 13) have to be arranged in an inclined manner on separate sheet metal supports, conductor films, or printed circuit boards. Using such supports and fastening the LEDs (10 to 13) is technically complex and costly. In order to be able to arrange the laterally radiating luminous means (10 to 13) in a simple, low-cost manner without using any additional supports, said luminous means (10 to 13) is provided with a fully reflecting surface (14), on which the beams (S) are reflected towards a reflector (3) that reflects the beams (S) in the direction of a light disk (2). The fully reflecting surface (14) can be arranged according to specific requirements in such a way that the light falls in the desired direction. No additional supports are required. The inventive luminous unit is preferably used in sideview mirrors of motor vehicles but can also be used in all areas of signal technology and illumination engineering.

The invention concerns a lighting unit, particularly as an auxiliary light in exterior rearview mirrors of motor vehicles, according to the preamble of claim 1.

Lighting units are known in which LEDs arranged at an angle are provided for lateral radiation of light. These LEDs are attached to separate sheet metal supports, so-called clinch plates, conductive foils, or printed circuit boards. The use of such supports and the fastening of LEDs thereto is relatively complicated and expensive.

The object of the invention is to design a lighting unit of this type such that the lighting means can be arranged for lateral radiation in a simple, economical manner which avoids additional supports.

This object is attained in a lighting unit of the generic type in accordance with the invention through the characterizing features of claim 1.

Since the lighting means has a fully reflective surface, the light in this region does not reach the outside. Thus, it is only necessary for the lighting means to be installed such that the light emerges in the desired direction, more particularly in a lateral direction. At the reflector, the rays are then reflected toward the lens. As a result of the fully reflective surface, the lighting means can be arranged such that the light falls in the desired direction as a function of the insert piece of the lighting unit according to the invention. The lighting means need not be installed at an angle, thus obviating the need for additional plates, conductive foils or printed circuit boards. As a result, the lighting unit is simple and inexpensive to manufacture.

Additional features of the invention may be found in the additional claims, the description and the drawings.

The invention is described in detail below on the basis of three example embodiments which are shown in the drawings.

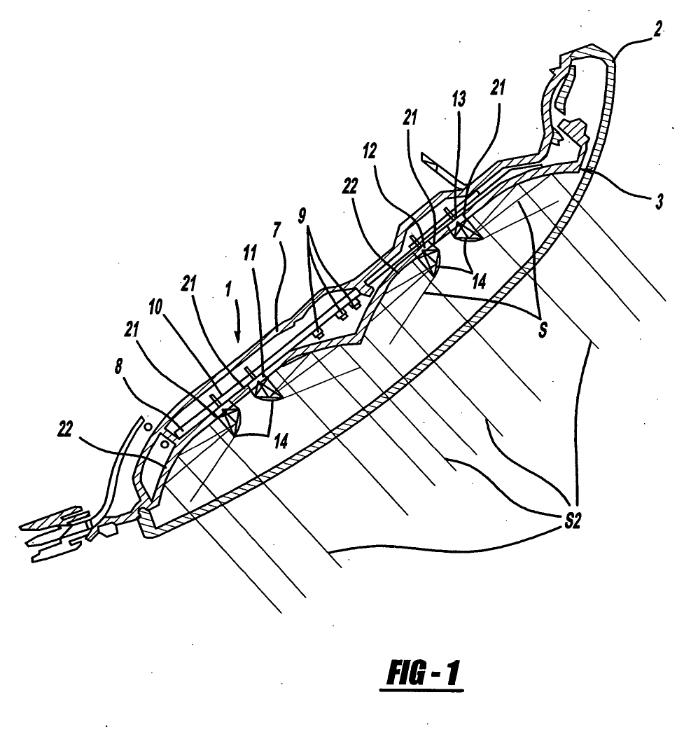

FIG. 1 shows a longitudinal section of a lighting unit according to the invention,

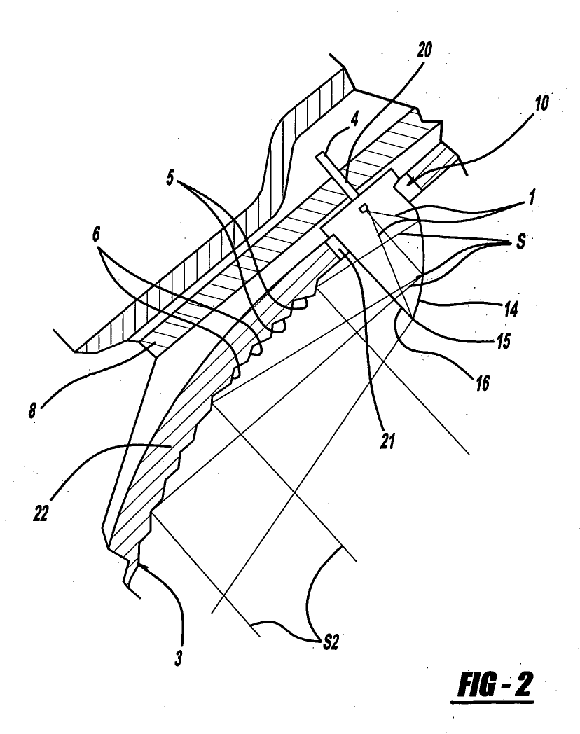

FIG. 2 shows an enlarged view of part of the lighting unit according to the invention with an LED,

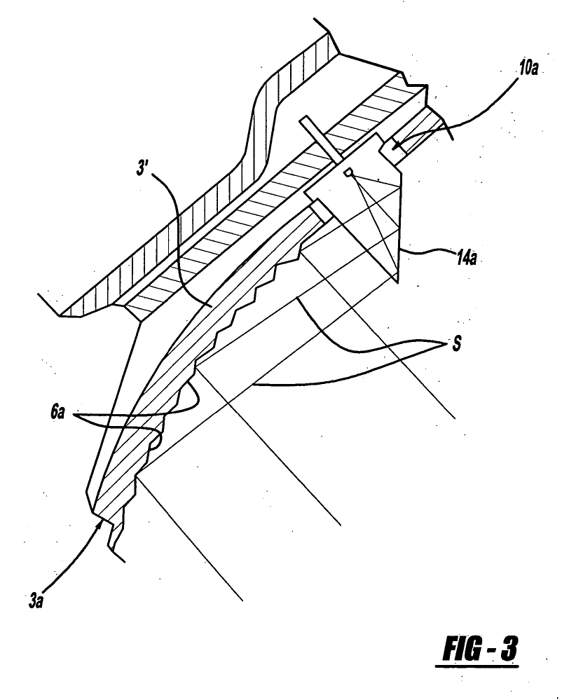

FIGS. 3 show additional embodiments of lighting units according to the invention in and 4 views as in FIG. 2.

FIG. 1 shows a lighting unit with a housing 1 whose housing opening is covered by a lens 2. Provided in the housing 1, opposite the lens 2 and a distance therefrom, is a reflector 3 whose inner side has individual reflector surfaces 5, 6 at which rays S from lighting means 10-13 are reflected toward the lens 2. A printed circuit board 8, which carries the lighting means 10-13 as well as additional electronic components such as resistors 9, lies between the housing rear wall 7 and the reflector 3.

The lighting means 10-13 are LEDs, which are soldered, welded or otherwise fastened to the printed circuit board 8. The lighting unit has multiple lighting means 10-13 located one behind the other and a distance apart. Depending on the design of the lighting unit, the lighting means may also be provided in a different arrangement.

The design and location of one of the lighting means with respect to the reflector 3 is described in detail on the basis of FIG. 2. The other lighting means are designed and arranged relative to the reflector 3 in the same way.

The LED 10 has feet 4, which extend through openings 20 in the printed circuit board 8 and are advantageously connected by soldering to conductive traces (not shown). The reflector 3 has a through-opening 21 through which the LED 10 extends. Said LED has an end face 14 with a convex outward curvature in longitudinal section at which the rays S1 passing from the LED 10 toward said end face 14 are fully reflected. The end face 14 can be mirror-finished on its inner surface for this purpose. As FIG. 2 shows, the end face 14 adjoins the lateral surface 16, which can lie on the surface of a cylinder, at an acute angle at the axially outer end and at an obtuse angle at the axially inner end. In this case, the LED 10 has a circular outline when viewed in the axial direction toward the end face 14. The end face 14 extends from the free end 15 of the LED 10 over more than half its height.

The rays S1 reflected at the end face 14 are deflected in the opposite direction in such a way that they pass through the lateral surface 16 and strike the reflector surfaces 6 which extend at an angle thereto. Said reflector surfaces lie on annular segments located coaxial to the center axis of the reflector 3. The part 22 of the reflector 3 which has the reflector surfaces 5, 6 has an approximately parabolic shape. The reflector surfaces 6 are designed such that the rays S1 are reflected toward the lens 2 approximately parallel to one another. The reflected rays S2 strike the lens 2 at approximately right angles (FIG. 1).

In place of the mirror finish, the end face 14 of the LED 10 can be provided with a coating or the like on its inner surface to achieve full reflection. However, the end face 14 can also be made of a fully reflective material while the lateral surface 16 is made of a transparent material.

As FIG. 1 shows, the reflector 3 consists of two identical reflector parts 22, which are advantageously designed as a single piece. Each reflector part 22 has two through-openings 21 next to one another at a distance, through each of which an LED 10, 11 and 12, 13 extends. Within each reflector part 22, the two LEDs 10, 1 1 and 12, 13 are arranged with mirror-image symmetry to one another such that the fully reflective end faces 14 face one another. As a result, the LEDs 10 and 11 or 12 and 13 emit light in opposite directions. The rays emitted by LEDs 10 and 12 strike the reflector surface 6, and the rays emitted by LEDs 11 and 13 strike the oppositely inclined reflector surfaces 5.

As a result of the embodiment described, the LEDs 10-13 need not be arranged at an angle for lateral radiation of light. An additional printed circuit board, an additional plate, and the like for the LEDs 10-13 are rendered unnecessary. The LEDs 10-13 can be attached to the printed circuit board 8 in a conventional soldering process so that the lighting unit is simple and inexpensive to manufacture.

As FIG. 3 shows, the LED 10a can also be designed such that the fully reflective surface 14a is flat and lies at an angle to the longitudinal axis of the LED 10a. In contrast to the above embodiment, the rays S in this case are reflected from the end face 14a parallel to one another. The reflected rays are reflected toward the lens 2 at the reflector surfaces 6a.

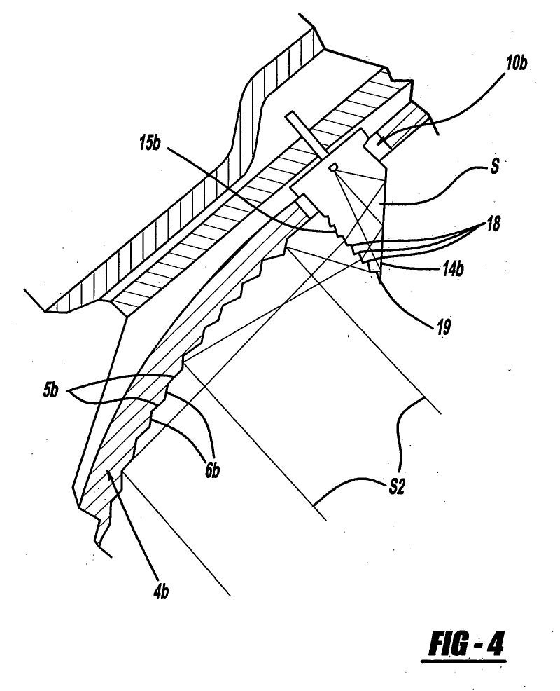

In the embodiment shown in FIG. 4, the LED 10b has the same angled end face 14b as the example embodiment in FIG. 3. The lateral surface 15b is provided with refractive optics in the area where the rays S that are fully reflected at the end face 14 emerge from the LED. Upon passing through the refractive optics 18, the rays S are bent such that they fall onto the reflector surfaces 6b. As in the other embodiments, the reflector surfaces 5b lie in the shadow of the rays S. The rays S2 reflected at the reflector surfaces 6b strike the lens 2, through which they exit the lighting unit. The rays S emerge from the LED 10b at different angles and are reflected parallel to one another at the reflector surfaces 6b. It is also possible to design the arrangement such that the rays S are scattered somewhat.

It is easily possible to mix the LEDs from FIGS. 1-4 in the lighting unit. It is also possible to provide the refractive optics 18 on the LED 10 from FIGS. 1 and 2. The lighting unit can be optimally adapted to the application in this way.

The lighting unit is advantageously used as an auxiliary light in outside rearview mirrors of motor vehicles. It can, of course, also be used in all areas of signaling or lighting.

1. Lighting unit, particularly as an auxiliary turn signal light in exterior rearview mirrors of motor vehicles, having at least one lighting means, particularly an LED, and at least one reflector that reflects the rays coming from the lighting means toward a lens, characterized in that the lighting means (10-13; 10a; 10b) has at least one fully reflective surface (14; 14a; 14b) at which the rays are reflected to the reflector (3).

2. Lighting unit according to claim 1, characterized in that the fully reflective surface (14; 14a; 14b) lies at an angle to the axis of the lighting means (10-13; 10a; 10b).

3. Lighting unit according to claim 1 or 2, characterized in that the reflective surface (14; 14a; 14b) has a reflective coating and/or mirror finish and/or is made of a reflective material.

4. Lighting unit according to one of claims 1-3, characterized in that the fully reflective surface (14a; 14b) is flat.

5. Lighting unit according to one of claims 1-3, characterized in that the fully reflective surface (14) has a convex outward curvature.

6. Lighting unit according to one of claims 1-5, characterized in that the fully reflective surface (14; 14a; 14b) extends over a part of the height of the lighting means (10- 13; 10a; 10b).

7. Lighting unit according to one of claims 1-6, characterized in that the fully reflective surface (14; 14a; 14b) reflects the rays perpendicular to the axis of the lighting means (10-13; 10a; 10b).

8. Lighting unit according to one of claims 1-7, characterized in that the lateral surface (16, 16b) of the lighting means (10-13; 10a; 10b) is provided with refractive optics (18) in the region where the rays reflected at the fully reflective surface (14; 14a; 14b) pass through it.

9. Lighting unit according to claim 8, characterized in that the refractive optics (18) are formed by lenses.

10. Lighting unit according to one of claims 1-9, characterized in that two lighting means (10-13; 10a; 10b) arranged with mirror-image symmetry to one another are provided that emit light in opposite directions.

11. Lighting unit according to one of claims 1-10, characterized in that the reflector (3) has at least two reflector parts (22) next to one another.

12. Lighting unit according to claim 11, characterized in that each reflector part (22) has two lighting means (10-13; 10a; 10b) arranged with mirror-image symmetry to one another or identically to one another.
